(19) United States
(12) Patent Application Publication
(10) Pub. No.: US 2001/0046366 A1
(43) Pub. Date: Nov. 29, 2001

(54) System for controlling a remotely located video recording device

(76) Inventor: Robert Aaron Susskind, Reston, VA (US)

Correspondence Address: ROBERT SUSSKIND, P.O. Box 2354, Reston, VA, 20195, US

(21) Appl. No.: 09/828,663

(22) Filed: Apr. 6, 2001

Related U.S. Application Data
(60) Provisional application No. 60/196,173, filed on Apr. 11, 2000.

(51) Int. Cl. H04N 5/91; H04N 7/00; H04N 7/173

(52) U.S. Cl. 386/46; 725/87; 725/93

(57) ABSTRACT

A system for controlling operation of a remotely located video recording device includes at least one Video Recording Device connected to the Internet; at least one Internet access device connected to the Internet; and at least one Internet Remote Control Server connected to the Internet, whereby the Internet access device can control the Video Recording Device. The system also maintains and keeps the state of a user account representing the settings of a discrete user of a discrete VRD and exchanges changes in the states of the user account and of the VRD between the two. The system also accumulates each user's requests for recording of specific programs and communicates with other Servers to provide to other Servers statistical information regarding selected television programs.

This application is based on Provisional Application Ser. Number 60/196,173 filed on Apr. 11, 2000, titled “Internet Web-Based Operation of a Remotely Located Video Recording Device”

### BACKGROUND OF THE INVENTION

This invention relates generally to the field of digital communications, and more particularly to a system for controlling operation of a remotely located video recording device when there exists an Internet Server accessible via a Web-enabled device, and a video recording device (VRD) of the type commonly referred to as a Digital Video Recorder (DVR; also known as Personal Video Recorder), the VRD also being capable of connection to the Internet.

This invention utilizes as its basis the advent of both the Internet (World Wide Web or Web) and the Digital Video Recorder (DVR; also known as Personal Video Recorder, or PVR). Prior to the advent of the Web and DVR, the use of common programmable consumer devices was typically enabled via use of direct access to a device control panel or, more recently, via use of a wireless handheld remote control (typically using infrared signaling); In either case, the modification of the state of such devices was always performed when in direct proximity to the device (i.e., in the same room). A common example of such is the traditional Videotape Cassette Recorder (VCR). Some other more recent advances in “remote control” of consumer devices incorporate use of the telephone and the telephone “touch tone” signaling system—a common one being the home telephone message recorder, many examples of which may be accessed and controlled from a remote telephone. Other devices, such as home lighting systems and heating systems, have also been made available with telephone-based remote control features.

Commercial DVRs by design provide Internet-ready functionality used for access to television program listings data, as well as operating software updates. The common method a DVR uses to access the Internet is via a household telephone line that is the same as a common voice line. DVRs, as designed, do not extend a user's operational mode of the DVR interface beyond that of the common wireless remote control. Further, though a DVR can connect to the Internet, the Internet does not inherently provide extension of the operational mode of the DVR. Because there is inherent Internet compatibility of commonly manufactured DVRs, and because there is a very large user community for the general Internet, there appears both a technical and market opportunity to enable closer integration of the two. Further, as a primary function of a DVR is to enable recording of television programs when the user/owner of the DVR is not home, it stands to reason that the more flexible and accessible the programming features of a DVR are, the more useful it would become.

The invention claimed herein does extend the operational mode of the DVR by making it controllable via an Internet/Web-enabled device. This is accomplished by adding software to the DVR and providing software for an Internet Web Server. Additionally, the invention is accomplished as stated above by harnessing the interactivity of the Internet Web, as well as solving several communications problems that result from designing a Web-based control environment for a remotely located DVR.

Prior known inventions that may be related to the invention claimed herein are disclosed in the following U.S. Pat. Nos.:

5,982,445—which describes a method and apparatus for encoding HTML resources within a Television broadcast system, and use of an HTML-type interface on a television screen. This invention makes use of the Internet technology, but not the Internet environment itself. This invention claims to provide interactive control of a television or other household devices via an HTML interface. However, this invention maintains the user control within the old paradigm of being in direct proximity to the television device. In other words, it does not modify the user paradigm to extend it from the “direct proximity” shortcoming, to the “remotely located” paradigm. Therefore, while this invention applies some of the key Internet technology, it has a primary shortcoming of limiting the mode of operation to the traditional one of being in direct proximity to the end device.

5,963,264—which describes a means of controlling a video recording device via a television tuner which in turn is receiving commands for control of a video recording device via a data stream provided by a television broadcast head-end system. Although this provides a means of commanding a video recording device to record a specific television program without the need to directly interact with the video recording device, it does not solve the problem of enabling such a function without the need to be in direct proximity to the device. That is, because the television apparatus must be controlled using the traditional IR handheld controller (by definition in direct proximity to the device with which it communicates) to in turn generate an IR saturation frequency to control the video recording device (thus eliminating the need to use a handheld controller to control the video recording device itself), the end user is not able to effect control of the video recording device without being in its direct proximity.

5,990,884—which in part addresses a means of communicating with a remotely located device, such as a video recording device, over the Internet. However, there is a full requirement that an intermediate device (referred to in the description of the invention as an “Intelligent A/V Receiver”) be present and operational between the device to be controlled (e.g., a video recording device) and the end user device (e.g., a computer attached to the Internet). Further, the invention requires that the Intelligent A/V Receiver not be embodied as an Internet Server, but rather as a device locally resident to the devices to be controlled (e.g., a video recording device). Further, there is a full requirement that all communication between the end user device (e.g. a computer attached to the Internet) and the device to be controlled (e.g., a video recording device) be managed in a “point to point” manner, thereby foregoing the use of an Internet Server to act as the singular means of conveying and mediating information to and from the end point devices (end user device and device to be controlled). Further, there is no accounting for a means of enabling a plurality of end users wherein each end user is authorized to control only a specific end device(s). Further, there is no accounting for a means to store and convey at a later time, changes in state information between a user account and an end point device; that is, all communication between an end user device and a device to be controlled must occur in “real time”. Lastly, this configuration demands that very specialized technology (apparatus and software) be enabled in embodiment of the Intelligent A/V Receiver as well imbedded in the A/V System objects (Video device, Audio device, etc.).

### SUMMARY OF THE INVENTION

An object of the invention is to provide a system and method that uniquely enables any human or system operator to control the functions of a remotely located video recording device (VRD).

Another object of the invention is to enhance access to, usability of, and usefulness of a VRD by eliminating the requirement that a user be in direct proximity to the VRD for purposes of operational control.

A further object of the invention is to enhance access to, usability of, and usefulness of a VRD by enabling storage of the VRD's State parameters in a database, which is located remotely relative to the VRD. These State parameters include but are not limited to currently recorded video programs, currently pending VRD commands, new VRD commands that have not yet been transmitted to the VRD, prior recording history, VRD memory storage utilization, and VRD television program lineup and listings.

An additional object of the invention is to enhance usability of, and usefulness of a VRD by enabling scheduled and unscheduled updates between a database of VRD State parameters and a remotely located VRD by means of a network.

Yet another object of the invention is to provide television viewer demographic statistics as a function of storage of each individual users' request to record a program.

Another object of the invention is to enable advertisers to target ads to specific users based on demographic information of viewing habits.

In accordance with a preferred embodiment of the present invention, a system for controlling operation of a remotely located video recording device comprises at least one Video Recording Device (VRD) connected to the Internet; at least one internet access device connected to the Internet; at least one Internet Remote Control Server connected to the Internet which includes a database suitable for creating, storing and retrieving VRD operational control and usage data for a VRD (“state” information), and whereby the Internet access device can control the Video Recording Device.

Other objects and advantages of the present invention will become apparent from the following descriptions, taken in connection with the accompanying drawings, wherein, by way of illustration and example, embodiments of the present invention are disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows one embodiment of the present invention as applied in the operational environment defined herein; and

FIG. 2 depicts another embodiment of the present invention as applied in the operational environment defined herein; and

FIG. 3 depicts another embodiment of the present invention as applied in the operational environment defined herein; and

FIG. 4 depicts a typical users interaction with a typical embodiment including the embodiment's interaction with a user's Video Recording Device.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### A. Terminology

1. Internet—is a term used to mean the most widely recognized interconnection network deployed today. The Internet is a continuously changing coupling of networks with many thousands of computers at its nodes, some computers acting as providers of information, and some acting as requesters of information.

2. World Wide Web (or Web, WWW)—is a term used to mean the common method for accessing and utilizing content (also called “resources”) that is managed within the Internet.

3. Web Site or Internet Web Site Host—is a term used to mean a type of host computer on the Internet that provides content to WWW users.

4. Server or Host Server or Internet Server or Internet Remote Control Host Server—is a term used to mean any Internet-based computer that manages content or other data or information and has a means of brokering requests for information from other Internet computers.

5. Television Listings—is a term used to mean a database of standardized format that articulates the time and program to be broadcast in a region by a television program provider. An example of a provider in the U.S.A. of Television Listings is Tribune Media Services (TMS).

6. Video Recording Device (VRD)—is a term used to mean a device that, when attached to a television signal provider, can be programmed to record a television signal. For purposes of the invention claimed herein, additionally, a VRD is characterized as having the inherent capability to connect to the Internet and communicate with a Server. Commonly, though not a requisite for the invention claimed herein, a feature of a Video Recording Device of the type pertinent to the invention claimed herein, is that its means of storage is that of a common computer hard disk rather than common videotape. The claims made herein would be applicable to any such device, examples being those provided by the following companies: Microsoft (UltimateTV), and TiVo, as well as manufacturers of products licensed by the preceding companies, including Sony. Additionally, a Video Recording Device may also be embodied by a personal computer that contains all the common personal computer components as well as a television tuner card, software that simulates the functionality of a VRD, and a method of connection to the Internet. For purposes of defining the invention claimed here, the terms Personal Video Recorder (PVR) and Digital Video Recorder (DVR) are synonymous with the term Video Recording Device (VRD).

7. Internet Web Access Device—is a term used to mean any machine that can connect to the Internet and communicate with a Web Site via common HTML (Hypertext Markup Language—the common language of the World Wide Web); common examples being a personal computer, a handheld computer, or a cell phone.

### B. Description of Drawings

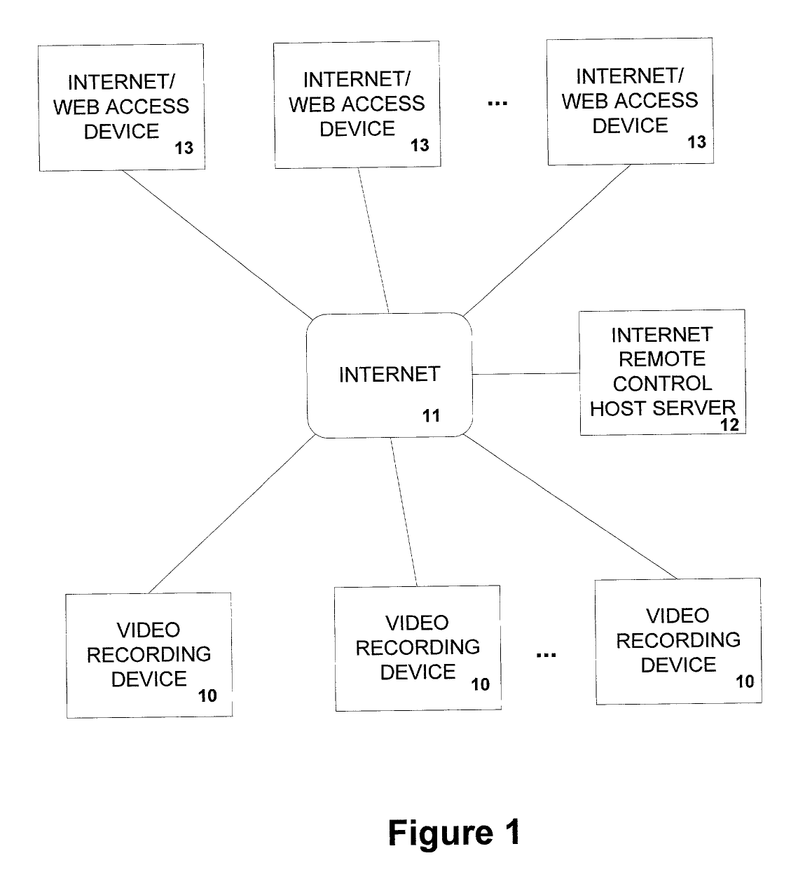

FIG. 1 depicts an operational environment of the invention claimed herein, whereby a plurality of Internet Web Access Devices 13 are connected to the Internet 11 and communicate via standard HTML interfaces with the Internet Remote Control Host Server 12. The Internet Web Access Devices may be, for example, a personal computer, a handheld computer, or a cellular telephone. A plurality of Video Recording Devices 10 is similarly connected to the Internet 11 and communicate with the Internet Remote Control Host Server 12 through standard communications links such as telephone lines, cable, fiber optic, or satellite.

The embodiment of the invention claimed herein is comprised of software that resides on the Internet Remote Control Host Server 12 and software that resides on the Video Recording Device 10. The implementation of the software module identified on Internet Remote Control Host Server 12 may be accomplished using commercially known development environments, one such example being Java Servlets and Java Servlet Pages. The implementation of the software module identified on Video Recording Device 10 may be accomplished using a development environment specific to the implementation of the Video Recording Device 10, which may range from a proprietary environment to an “open” environment such as a version of Microsoft Windows. There is no limitation on the implementation and development environment of the Video Recording Device 10; however, a singular, common implementation of the software module identified on Video Recording Device 10 for all cases of VRD's 10 is not probable.

FIG. 1 shows that a Video Recording Device 10 may be operated from a location other than that of direct proximity to a Video Recording Device 10 via any instance of Web Access Devices 13. There is no practical limitation of the number of Web Access Devices 13, nor the number of Video Recording Devices 10 that participate in the processes described herein. The scalability of the invention has no limits below those of the limits of the state-of-the-art of the Internet and Internet Sever technology.

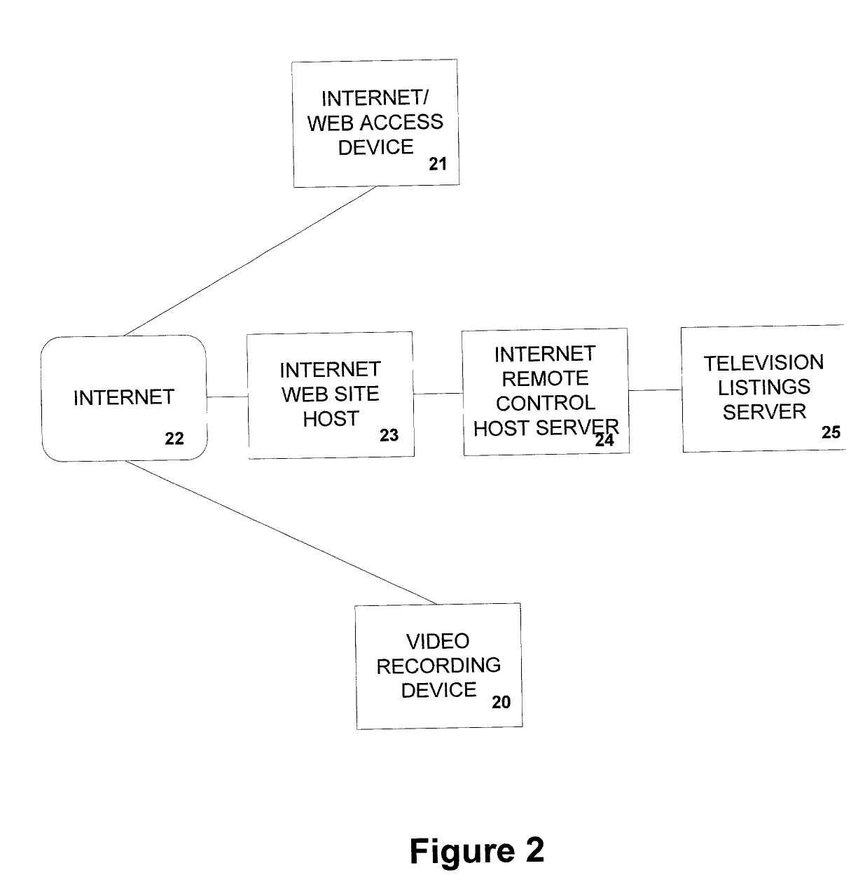

FIG. 2 depicts a standard configuration and use-case (example of a real-world application) as follows:

The Internet Web Access Device 21 is operated by making a standard connection to the Internet from anywhere in the world. The Internet Web Access Device 21 runs a standard HTML Web browser that is pointed to a URL for the Internet Web Site Host 23, which may be any commercial Web Site, for example: “www.sony.com”. The Web Site Host 23 provides the Web Access Device browser 21 with HTML pages that provide all the interface components required to operate the Video Recording Device 20. These HTML pages are in effect a simulation of the Video Recording Device 20 on-screen interface, but not necessarily visually identical to each other. The essential functions of the Video Recording Device 20 are presented in the HTML pages, including, but not necessarily limited to: View Program Listings, View Programs Scheduled for Recording, View Recorded Programs, Erase a Recorded Program, View Minutes of Storage Available. The values for the functions listed in the previous sentence are supplied by the Internet Remote Control Host Server 24, for example: View Programs Scheduled for Recording=“Cheers, Saturday 10:00 PM, Channel 12”. The values for View Program Listings are originated by the Television Listings Server 25, which is a 3rd-party commercial server that is not a component of the invention claimed herein.

The Internet Remote Control Host Server 24 also provides information to the Internet Web Access Device 21 browser pertaining to the “last known state” of the remotely located Video Recording Device 20. This information enables the Internet Web Access Device 21 to see settings that may have been changed by a user who is or was in direct proximity to the Video Recording Device 20. This is accomplished by enabling a set of user accounts on the Internet Remote Control Host Server 24, each user account being a unique data set pertaining to a specific user and a specific Video Recording Device 20. Every time a discreet change or set of changes (within the context of a session) is made to the user account via the Internet Web Access Device 21 or to the Video Recording Device 20, a process is initiated to synchronize the user account and Video Recording Device 20.

The following common cases depict the process for synchronization:

a. A change to the VRD settings in the user account is made via the Internet Web Access Device 21—in this case, a process is initiated by the Internet Remote Control Host Server 24 to connect to the Video Recording Device 20 associated with the specific user account and send the new settings to the Video Recording Device 20.

b. A change to the settings of the Video Recording Device 20 is made by a user in direct proximity to the Video Recording Device 20—in this case, a process is initiated by the Video Recording Device 20 to connect the Video Recording Device 20 to the Internet Remote Control Host Server 24 and send the new settings to the user account associated with the specific Video Recording Device 20 on the Internet Remote Control Host Server 24.

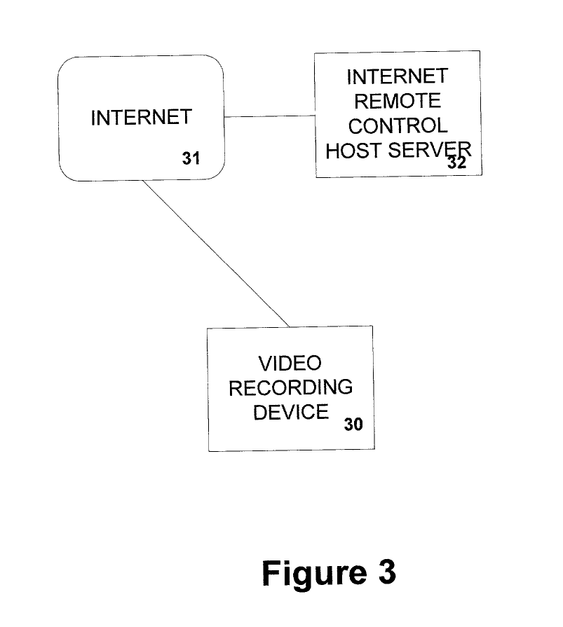

FIG. 3 focuses on the essential components of the invention claimed herein, namely, the software modules residing on a Video Recording Device 30 and an Internet Remote Control Server 32.

The software module residing on Internet Remote Control Server 32 is comprised of both executable code and a database. The code functions include methods of serving Web pages, receiving HTML streams from a Web browser, interpreting streams, reading and writing data to and from the database, creating and removing user accounts, providing username and password-based secured login to user accounts, communicating with other Internet Servers, and communicating with a Video Recording Device 30. The database maintains all user account settings and values, and provides a source for reporting on overall user groups' selections with respect to television programs selected for recording (i.e., the unique program ratings feature that is fully accurate and does not depend on statistical modeling). The database associates each user account on 32 with a specific Video Recording Device 30, including all the pertinent information regarding the Video Recording Device 30 for purposes of electronically contacting and communicating with the Video Recording Device 30.

These two software modules (on Video Recording Device 30 and Internet Remote Control Server 32) enable unique communication of state data between the two objects 30 and 32:

a. whenever a change of state is made on a user account on Internet Remote Control Server 32 in the context of a discreet session, a process on Internet Remote Control Server 32 establishes communication with Video Recording Device 30 and subsequently conveys the change from 32 to Video Recording Device 30.

b. whenever a change is made on a video recording device 30, a process on 30 establishes communication with Internet Remote Control Server 32 and subsequently conveys the change from Video Recording Device 30 to Internet Remote Control Server 32.

c. whenever a change is made on either Video Recording Device 30 or Internet Remote Control Server 32 and a subsequent conveying of said change from one object to the other creates a conflict such that one change must be selected and kept, and the other change rejected and deleted, rules encoded in the software modules in Video Recording Device 30 and Internet Remote Control Server 32 shall resolve the conflict, select one and only one change, and permute the change to both objects and discard the unused change.

d. There are 2 distinct classes of modes of communication from 32 to Video Recording Device 30 enabled by the invention claimed herein:

1) Mode 1 indicates that the Video Recording Device 30 will ping the Internet Remote Control Host Server 32 on a timed interval basis and check for the presence of changed state information. In this mode, Video Recording Device 30 initiates update requests. An “update available” data bit flag is employed in the user account on 32 to initially provide the update checking routine with the fundamental understanding as to whether any changes have been made. Conversely, this mode may be deployed in the opposite direction, wherein the Internet Remote Control Host Server 32 pings the Video Recording Device 30. A further alternative implementation to this mode provides for a ping of one object to the other whenever one object's settings have been modified; this displaces the timed interval basis for checking for updates. All cases for this mode require a direct IP persistent connection between Video Recording Device 30 and Internet Remote Control Server 32.

2. Mode 2 indicates that an Internet Remote Control Host Server 32 process will contact the Video Recording Device 30 by initiating a telephone call. This mode is used when there is no direct IP connection between Video Recording Device 30 and Internet Remote Control Server 32. In this case the user account database on 32 has the telephone number associated with Video Recording Device 30. There are two options for this mode: In the first option, the telephone line to which Video Recording Device 30 is connected does not have a Caller ID feature enabled. In this case, Internet Remote Control Server 32 call the Video Recording Device 30 issuing a unique telephone ringing sequence that VRD 30 recognizes as a call that can only come from Internet Remote Control Server 32. This is a useful feature of the invention because it eliminates the need for VRD 30 to be the only device attached to the telephone line (i.e., regular telephones and telephone answering machines may also be attached to the line). A proposed unique ring sequence is: A single ring followed by brief pause (5 to 30 seconds), then a 2nd single ring followed by brief pause (5 to 30 seconds of silence), then a 3rd ring within the following 30 second window. All other ring sequences are ignored and not picked up by VRD 30 (i.e., VRD software assumes that such calls are regular incoming voice calls). In the second option, the invention claimed herein will function by having Internet Remote Control Server 32 call Video Recording Device 30 with a consistent set of outbound (from) telephone numbers (i.e., the numbers from which Internet Remote Control Server 32 is calling); in this option, VRD 30 has been pre-programmed with the outbound numbers, and the telephone line to which VRD 30 is attached has an active Caller ID feature. The software on VRD 30 will then monitor the Caller ID field between the 1st and 2nd rings. If the incoming number matches one of the known Internet Remote Control Host Server 32 telephone numbers, VRD 30 will pick up the line. Otherwise, the VRD 30 will ignore the call.

All updates to settings on either Internet Remote Control Server 32 or Video Recording Device 30 are conveyed between Internet Remote Control Server 32 and Video Recording Device 30 by a standardized record format that may be defined by the implementation of the invention claimed herein, and not necessarily of any format enforced by the invention; the software on Internet Remote Control Server 32 and Video Recording Device 30 is able to parse and interpret the record format for purposes of understanding what actions need to be taken and what data needs to be modified. Additionally, there are “handshaking” and error routines. Each of the functions defined in this paragraph would be readily understood, recognized as necessary, and could be designed and implemented by any person skilled in the art.

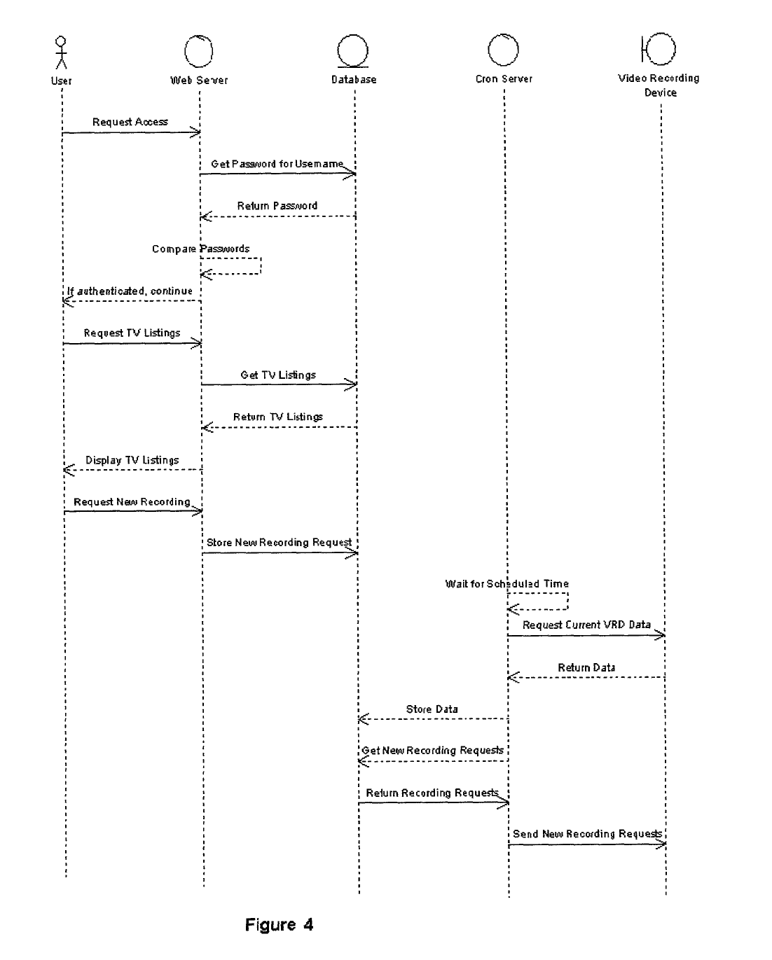

FIG. 4 consists of a sequence diagram, which depicts a User 41 having a Web enabled browser with Internet access, interacting with a Web Server 42, of a typical implementation of the preferred embodiment. FIG. 4 specifically depicts a use-case associated with a Web user request to update the recording state of a remotely located VRD. In the sequence of events, User 41 starts by requesting access to the system from Web Server 42. Web Server 42 sends a username keyed request to Database 43 for the corresponding password. Database 43 returns the password to Web Server 42. Web Server 42 compares the password returned from Database 43 with the password sent by User 41. If the passwords match, then the sequence is allowed to continue; otherwise an error code is returned. If the username and password are accepted, then the main control web page is sent from the Web Server 42 to the Web browser of User 41. In this sequence diagram User 41 then requests a display of the current television listings. Web Server 42 retrieves the television listings from Database 43. Web Server 42 sends the television listings as html code to the Web browser of User 41. User 41 then selects a television show that User 41 would like to record on VRD 45. The new recording request is sent to Web Server 42, which in turn passes the request on to Database 43 for storage in the user account.

At some later pre-scheduled time, or interactively depending upon the implementation, Cron Server 44 contacts Video Recording Device 45 (the discreetly identified VRD associated with the account of User 41 in Database 43) and requests updated status data including current programming requests and currently stored video programs. Video Recording Device 45 returns the requested data to Cron Server 44. Cron Server 44 stores the retrieved data into the user account of Database 43. Cron Server 44 then retrieves any new recording requests (or other command settings changes) from Database 43 and passes them on to Video Recording Device 45, which in turn updates the state of Video Recording Device 45 to reflect the change to the user account of Database 43. (As mentioned prior, conflicts that arise per changes to user account or VRD settings are resolved via rules logic encoded in the software of Database 43 and VRD 45.)

### C. Results and Advantages

An operator in any location in the world wherein there is an Internet Web-enabled device may command a remotely located Video Recording Device to perform any common VRD function.

As the use of this invention in commercial applications becomes greater, many users will make requests to record television programs on their remotely located VRDs. Each request may be recorded in a database, as noted above, and thereby over time, a direct correlation between a user account and VRD, and a population of such pairings, with specific television recording habits may be drawn. This result provides a unique method of establishing television viewing preferences, the uniqueness of which, by definition, does not depend on statistical sampling methods (the common method), but rather, provides direct correlations between a user account and a request to record a program. The commercial application of this data may be highly valuable to marketers who wish to understand better what television programs are being viewed and by what categories of viewers, in what percentages of a population.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for controlling operation of a remotely located video recording device comprising:
at least one Video Recording Device connected to the Internet;
at least one Internet access device connected to the Internet;
at least one Internet Remote Control Server connected to the Internet,
whereby the Internet access device can control the Video Recording Device.

2. A system as claimed in claim 1 further comprising a means for maintaining and keeping the state of a user account representing the settings of a discrete user of a discrete remotely located VRD.

3. A system as claimed in claim 2 wherein the means exchanges changes in the states of the user account.

4. A system as claimed in claim I further comprising a means for accumulating each user's requests for recording of specific programs.

5. A system as claimed in claim 4 wherein the means communicates with other Servers to provide to other Servers statistical information regarding selected television programs.
